(19) United States
(12) Patent Application Publication
(10) Pub. No.: US 2025/0218202 A1
(43) Pub. Date: Jul. 3, 2025

(54) METHOD FOR ESTABLISHING ESTIMATION MODEL OF TOTAL NUMBER OF CELLS OF THREE-DIMENSIONAL CELL CLUSTER IN THYROID PUNCTURE SMEAR

(71) Applicant: Nanjing Hospital of Traditional Chinese Medicine Affiliated to Nanjing University of Chinese Medicin, Nanjing City (CN)

(72) Inventors: Kang WANG, Nanjing City (CN); Zhenghua Wang, Nanjing City (CN); Na SHI, Nanjing City (CN); Zinan YE, Nanjing City (CN); Wenqian ZHOU, Nanjing City (CN); Futing TANG, Nanjing City (CN); Chonggao WANG, Nanjing City (CN); Yaqun LIU, Nanjing City (CN)

(73) Assignee: Nanjing Hospital of Traditional Chinese Medicine Affiliated to Nanjing University of Chinese Medicin, Nanjing City (CN)

(21) Appl. No.: 18/808,604

(22) Filed: Aug. 19, 2024

(30) Foreign Application Priority Data
Dec. 28, 2023 (CN) 202311840518.1

(51) Int. Cl. G06V 20/69; G06T 7/00; G06T 11/20

(52) U.S. Cl. CPC G06V 20/698; G06T 7/0012; G06T 11/203; G06T 2207/30024

(57) ABSTRACT

Provided is a method for establishing an estimation model of a total number of cells of a three-dimensional cell cluster in a thyroid puncture smear. The method for establishing the estimation model of the total number of the cells of the three-dimensional cell cluster in the thyroid puncture smear includes following steps: S1: selecting a three-dimensional cell cluster; S2: first drawing a big circle, and enclosing the three-dimensional cell cluster into the big circle; S3: drawing small circles with actual diameters of follicular cells, and surrounding the small circles around the big circle; adjusting a diameter of the big circle properly during a drawing process, making the small circles completely surround the big circle with a total number of the small circles are divisible by 4; and S4: marking black circles with a same size as the small circles to supplement cell-free areas.

### CROSS-REFERENCE TO RELATED APPLICATIONS

This application claims priority to Chinese Patent Application No. 202311840518.1, filed on Dec. 28, 2023, the contents of which are hereby incorporated by reference.

### TECHNICAL FIELD

The disclosure relates to the technical field of medical treatment, and in particular to a method for establishing an estimation model of a total number of cells of a three-dimensional cell cluster in a thyroid puncture smear.

### BACKGROUND

The newly published third edition of the thyroid cytology The Bethesda System (TBS) report system has added and expanded new contents on the basis of the original “microfollicle” structure. The new contents require that when a three-dimensional cell cluster meets the following two limited conditions: (1) there are less than 15 follicular cells around the three-dimensional cell cluster; (2) peripheral cells are arranged in a whole circle, at least in ⅔ circle, the three-dimensional cell cluster also belongs to the category of “microfollicle” structure, that is, the three-dimensional cell cluster type “microfollicle”. The “microfollicle” structure is an important basis for the diagnosis of follicular neoplasm in thyroid fine needle aspiration cytopathology. When the obvious “microfollicle” structure is observed under the microscope, cytopathologists believe that thyroid nodules with this structure have a 30% to 60% risk of being confirmed as malignant or follicular neoplasm with malignant potential by postoperative histopathology. Therefore, when the obvious “microfollicle” structure is observed under the microscope, the cytopathologist will diagnose the obvious “microfollicle” structure as a follicular neoplasm, and the surgeon will choose surgical resection of the tumor for further histopathological diagnosis. The definition of “microfollicle” in the first and second editions of TBS report system is “crowded and tiled follicular cells, with less than 15 cells arranged in a circle, at least in ⅔ circle”. The third edition of TBS report system for thyroid cytology, newly published in 2023, added three-dimensional cell clusters that meet the above conditions into the category of “microfollicle” structure. The most important basis is that it is found that the three-dimensional cell cluster type “microfollicle” structure has higher prompt value in the risk of thyroid follicular neoplasm.

The original definition of “microfollicle” structure in the TBS report system of the first and second editions comes from a study on the consistency interpretation standard of “microfollicle” structure. The study requires that the total number of cells in the included independent follicular cell cluster should be less than 50. Finally, all experts unanimously interpreted the “microfollicle” structure is characterized by: crowded and tiled follicular cells, with less than 15 cells arranged in a circle, at least in ⅔ circle. At that time, three-dimensional cell clusters were classified by experts as medium follicles and were not included in the category of “microfollicle” structure. The total number of cells of the three-dimensional cell cluster is obviously more than 15, which is also an important reason why the three-dimensional cell cluster has not been defined as a “microfollicle” structure by the TBS report system in the first and second editions. Whether from the inclusion criterion of “less than 50 cells” or the quantitative limit of “less than 15 cells”, it is clear that the key issue of the definition of “microfollicle” is the counting of the total number of cells in a cell cluster and the evaluation of the upper limit of the total number. The definition of “microfollicle” in the third edition mainly defines the number of follicular cells (less than 15) around the three-dimensional cell cluster type “microfollicle” and the structural integrity (arranged in a circle, at least in ⅔ circle). The purpose of this standardized definition is to keep the three-dimensional cell cluster type “microfollicle” consistent with the definitions in the first and second editions. It may be seen that when the peripheral cells meet the above two limited conditions, the total number of follicular cells that may be accommodated in the circle surrounded by the peripheral cells is relatively limited. Since the total number of cells is relatively limited, the total number should be calculated through research. However, at present, no research has discussed the “problem of cell capacity in the circle surrounded by peripheral cells around three-dimensional cell cluster”, which involves the problem of the total number of cells of the three-dimensional cell cluster. Whether the upper limit of the total number of three-dimensional cell cluster type “microfollicle” cells may be determined directly determines whether the three-dimensional cell cluster may be accurately judged as a “microfollicle” structure. The proposal and research of this problem has very important academic value and practical significance. But up to now, there is no research on the determination of the upper limit of the total number of three-dimensional cell cluster type “microfollicle” cells. The main reasons are as follows: firstly, the definition of three-dimensional cell cluster type “microfollicle” was newly added in 2023, and the application of this definition and the discovery of related problems need to be tested in practice and accumulated in time; secondly, there has always been a lack of reasonable counting and evaluation schemes.

Therefore, it is necessary to provide a new method for establishing an estimation model of a total number of cells of a three-dimensional cell cluster in a thyroid puncture smear to solve the above technical problems.

### SUMMARY

The technical problem to be solved by the disclosure is to provide a method for establishing an estimation model of a total number of cells of a three-dimensional cell cluster in a thyroid puncture smear, which may reduce the influence of external force on the three-dimensional cell cluster and make the cell distribution of the three-dimensional cell cluster more in line with the rules and orders in human histology.

In order to solve the above technical problems, the method for establishing the estimation model of the total number of the cells of the three-dimensional cell cluster in the thyroid puncture smear provided by the disclosure includes following steps:
S1: selecting a three-dimensional cell cluster;
S2: first drawing a big circle, and enclosing the three-dimensional cell cluster into the big circle;
S3: drawing small circles with actual diameters of follicular cells, and surrounding the small circles around the big circle; adjusting a diameter of the big circle properly during a drawing process, making the small circles completely surround the big circle with a total number of the small circles are divisible by 4;
S4: marking black circles with a same size as the small circles to supplement cell-free areas;
S5: using a model to count a total number of cells in crowded and overlapping unidentifiable areas of the three-dimensional cell cluster; then, adding a total number of cells in tiled identifiable areas; finally, subtracting supplemented cells, and finally determining a total number of real cells of the three-dimensional cell cluster; and
S6: by comparing the total number of the real cells of the three-dimensional cell cluster with an upper limit of total number of standardized three-dimensional cell cluster type “microfollicle” cells, determining the real cells of the three-dimensional cell cluster as microfollicles or medium follicles.

Optionally, in the S1, the three-dimensional cell cluster with crowded and overlapping unidentifiable follicular cells are selected.

Optionally, in the S2, the big circle represents a circle surrounded by the peripheral cells, and all the crowded and overlapping unidentifiable areas of the three-dimensional cell cluster are enclosed in the big circle.

Optionally, in the S3 and the S4, the small circles represent peripheral follicular cells; in the S3, when the small circles are completely around the big circle while the total number of the small circles is completely divided by 4, tiled cells and cell-free areas are required not to be enclosed in the big circle.

Optionally, in the S5, a “2[(N/π)−1]²” model is used to count the total number of the cells in the crowded and overlapping unidentifiable areas of the three-dimensional cell cluster.

Optionally, the upper limit of the total number of the three-dimensional cell cluster type “microfollicle” cells is 70.

Compared with the related art, the method for establishing the estimation model of the total number of the cells of the three-dimensional cell cluster in the thyroid puncture smear provided by the disclosure has the following beneficial effects.

The disclosure provides the method for establishing the estimation model of the total number of the cells of the three-dimensional cell cluster in the thyroid puncture smear, which may reduce the influence of external force on the three-dimensional cell cluster, so that the cell distribution of the three-dimensional cell cluster is more in line with the regular and orderly characteristics of human histology. The method may avoid the problem that the three-dimensional cell clusters conforming to the definition of “microfollicle” do not match with the actual three-dimensional cell clusters with irregular contours and inconsistent numbers of peripheral cells, so that the definition of the three-dimensional cell cluster structure model is solved by the model itself without confusing model problems with actual problems.

### BRIEF DESCRIPTION OF THE DRAWINGS

FIG. 1 is a schematic diagram of a standardized three-dimensional cell cluster type “microfollicle” structure model according to a method for establishing an estimation model of a total number of cells of a three-dimensional cell cluster in a thyroid puncture smear provided by the disclosure.

FIG. 2 is a schematic diagram of a three-dimensional cell cluster in a thyroid puncture smear according to a method for establishing an estimation model of a total number of cells of a three-dimensional cell cluster in a thyroid puncture smear provided by the disclosure.

FIG. 3 is a schematic diagram showing that a part surrounded by a big circle is a crowded and overlapping unidentifiable area of FIG. 2, and the outside of the big circle is a tiled identifiable area.

FIG. 4 is a schematic diagram of 1-20 small circles representing peripheral follicular cells shown in FIG. 3.

FIG. 5 shows black circles representing supplemented cells of cell-free areas shown in FIG. 4.

FIG. 6 is a flowchart of a method for establishing an estimation model of a total number of cells of a three-dimensional cell cluster in a thyroid puncture smear provided by the disclosure.

### DETAILED DESCRIPTION OF THE EMBODIMENTS

The disclosure will be further described with reference to the attached drawings and embodiments.

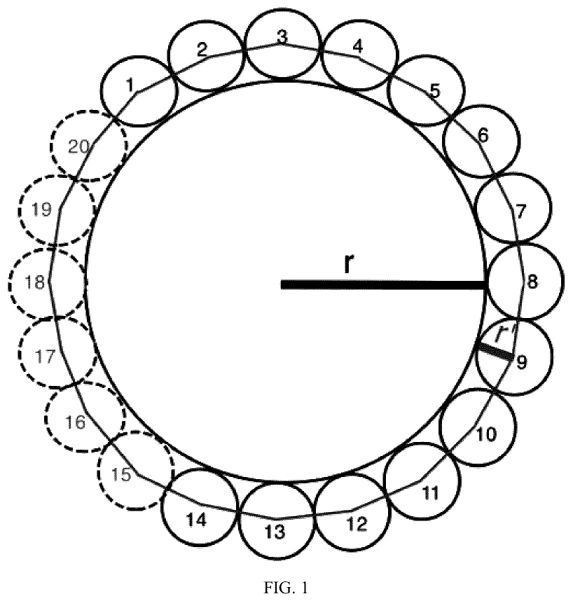

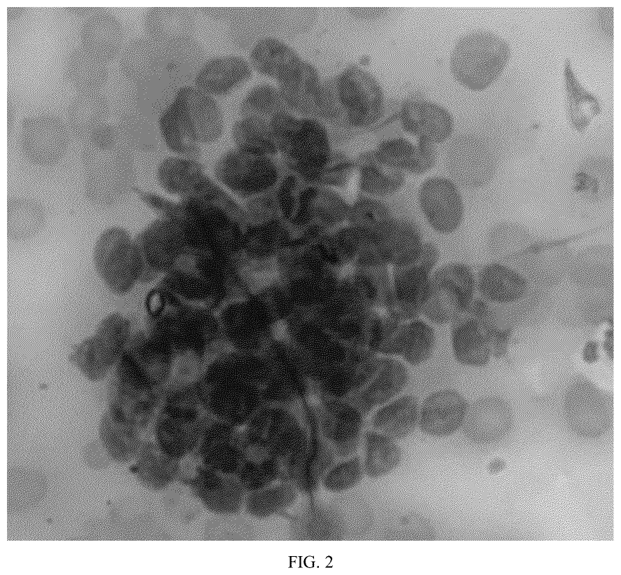

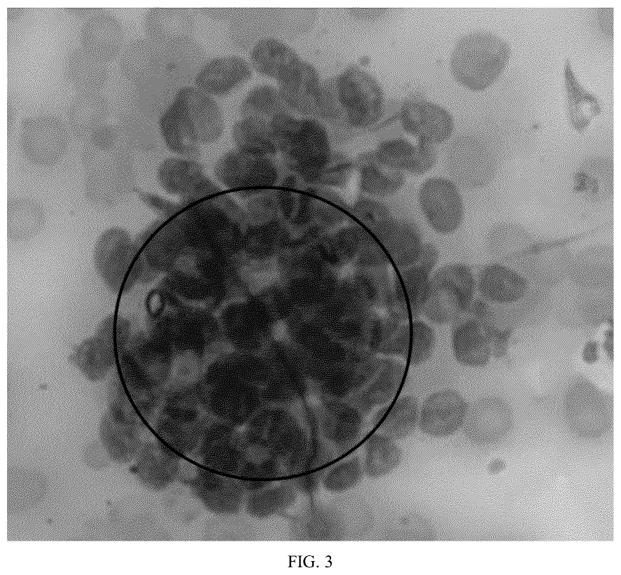

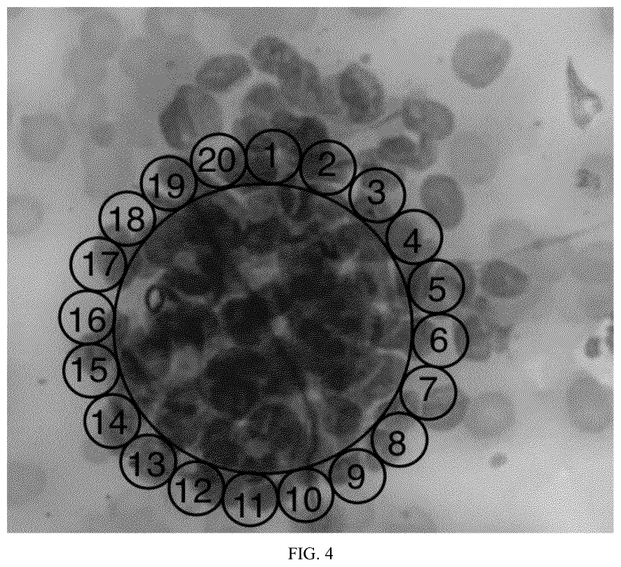

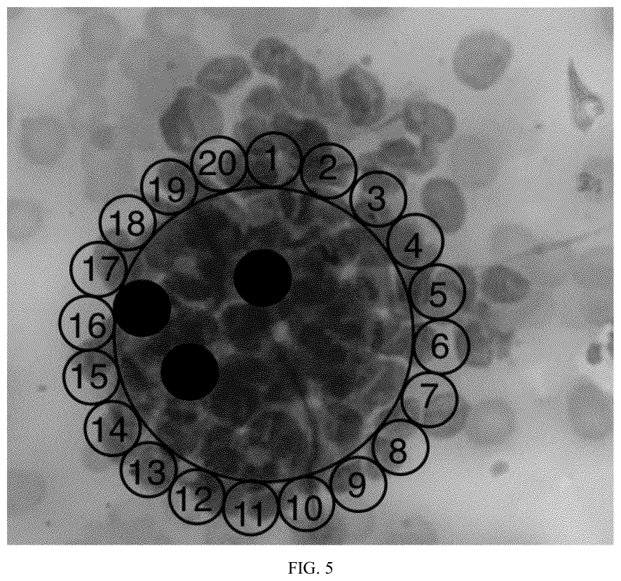

Referring to FIG. 1, FIG. 2, FIG. 3, FIG. 4 and FIG. 5, where FIG. 1 is a schematic diagram of a standardized three-dimensional cell cluster type “microfollicle” structure model according to a method for establishing an estimation model of a total number of cells of a three-dimensional cell cluster in a thyroid puncture smear provided by the disclosure, FIG. 2 is a schematic diagram of a three-dimensional cell cluster in a thyroid puncture smear according to a method for establishing an estimation model of a total number of cells of a three-dimensional cell cluster in a thyroid puncture smear provided by the disclosure, FIG. 3 is a schematic diagram showing that a part surrounded by a big circle is a crowded and overlapping unidentifiable area of FIG. 2, and the outside of the big circle is a tiled identifiable area; FIG. 4 is a schematic diagram of 1-20 small circles representing peripheral follicular cells shown in FIG. 3, and FIG. 5 shows black circles representing supplemented cells of cell-free areas shown in FIG. 4.

The three-dimensional cell clusters actually observed in thyroid puncture smears are not as standardized as the definition of three-dimensional cell cluster type “microfollicle”, and the three-dimensional cell clusters have certain uniqueness. (1) The counters of cell clusters are often irregular. It is mainly the result of the influence of external force in the process of puncture smear, leading to a great degree of uncertainty in the counting of peripheral cells and the evaluation of the structural integrity. The number of peripheral cells is likely to exceed the limit of 15, and the structural integrity may not reach the limit of one circle or at least ⅔ circle, which makes observers judge the “microfollicle” structure contradictory. (2) The arrangement of cells in the cluster is obviously crowded. This will lead to no basis and rules to follow when counting visually under the microscope, blind speculation and great deviation. Therefore, under the condition that the upper limit of the three-dimensional cell cluster type “microfollicle” cells may not be determined accurately and a reasonable plan for counting the total number of cells of the three-dimensional cell cluster has not been worked out, it is difficult for pathologists to accurately determine whether the three-dimensional cell cluster conforms to the “microfollicle” structure only by the number and the structural integrity of the peripheral cells of the three-dimensional cell cluster.

At first, the study on the “microfollicle” structure limits the total number of follicular cells in an independent cell cluster to less than 50. This upper limit is roughly estimated by the observer's subjective perception under the microscope, and is based on a relatively limited number of cases. Therefore, it is obviously not accurate and reasonable to take 50 cells as the upper limit of the total number of three-dimensional cell cluster type “microfollicle” cells. Moreover, it is found in practical work that although it is impossible to count accurately because of cell crowding and overlapping, the total number of cells in many three-dimensional cell clusters suggesting follicular neoplasm is indeed roughly estimated to exceed 50. There are some differences among different observers when counting visually under the microscope, especially when counting human cells at micron level. Although the cells around the three-dimensional cell cluster in the thyroid puncture smear are lightly shielded by cell crowding and overlapping, the boundary is relatively clear, and it is easy to visually count, but in many cases, the cells inside the three-dimensional cell cluster may only be observed that the crowded and overlapping nuclei are piled up together, and the nuclei themselves are deeply stained. In addition, the external force makes the contour of the cell cluster more irregular and the cells more crowded in the process of making the cell smear. The above reasons lead to the inability to accurately evaluate the visual counting under the microscope. The premise of artificial intelligence computer system aided counting is to require each cell to have enough recognition, that is, the target cells must be accurately labeled manually on the premise of clear recognition by human eyes, and then the labeled cell images are scanned and input into the computer system, so that the computer may save and accurately recognize these information. However, the cells in the three-dimensional cell cluster are crowded, and it is impossible to accurately label each cell under the microscope. In addition, some computer scanning and counting systems need special staining for cell smears before counting cells. However, thyroid puncture cell smears are required to be made into smears as soon as possible after the puncture needle takes samples and put in stationary liquid for preservation. All smears are unique and may not be copied again. Once special staining is carried out, the diagnostic value will be lost, which is not worth the loss.

In order to keep consistent with the definition of “microfollicle” in the first and second editions, the TBS report system in the third edition has standardized the definition of three-dimensional cell clusters, which not only makes it more reasonable for three-dimensional cell clusters to be included in the category of “microfollicle” structure, but more importantly, the number of peripheral cells and the integrity of peripheral cell arrangement structure of the three-dimensional cell cluster that meets the standardization limit no longer show great changes due to the intervention of external forces, thus stabilizing the concept of “microfollicle” structure of the three-dimensional cell cluster. Therefore, a theoretical foundation is laid for the successful implementation of establishing a standardized three-dimensional cell cluster type “microfollicle” structure model according to the structure concept, determining the upper limit of the total number of cells of the three-dimensional cell cluster and deducing the calculation formula of the total number of cells of the three-dimensional cell cluster. It is feasible to comprehensively evaluate the total number of cells by combining the overall outline of the three-dimensional cell cluster and the morphological characteristics of peripheral cells observed under the microscope. The shortcomings and defects of large subjective difference of visual estimation under microscope and the lack of theoretical basis are compensated to some extent.

The size of follicular cell mass and the degree of cell crowding are different in the puncture smears of thyroid follicular nodules of different natures. According to the size and degree of cell crowding, pathologists classify follicles into microfollicles, medium follicles and large follicles. In practical work, large follicles are easy to be identified, and the consistency of interpretation among different observers is also high. The characteristics of large follicles are that the follicular cells are laid flat and honeycomb, the cells are not crowded and there is a certain cell spacing, the cell fragments are often large, and there is no fiber blood vessel axis passing through them. Although it is easy to count large follicular cells, large follicular cells are generally not counted in clinical work because large follicular cells are clear cytological features of benign follicular lesions. As mentioned above, microfollicles have a clear definition and morphological characteristics, but there is actually no clear dividing line between microfollicles and medium follicles in cytological characteristics, only the difference in the size of follicular cell clusters, and cells are often arranged in crowded three-dimensional cell clusters, so the third edition of TBS report system has specially added two limited conditions for three-dimensional cell clusters that meet the definition of “microfollicle” (see above for details). In this way, the concept of three-dimensional cell clusters that conform to the “microfollicle” structure is standardized, and the structure of the three-dimensional cell clusters becomes stable (the actually observed three-dimensional cell clusters often have irregular contours and the number of peripheral cells changes greatly due to the action of external forces), which provides a certain basis for the division of “microfollicles” and medium follicles. The main purpose of dividing the microfollicles and medium follicles is based on the diagnostic value of “microfollicles” in follicular neoplasm, but the basis of this division is not based on the essential differences in morphological characteristics between “microfollicles” and “medium follicles”, but is artificially defined and distinguished. Three-dimensional cell clusters that meet the standardized definition of “microfollicle” are all defined by a regular circle (at least ⅔ circle) surrounded by peripheral cells, but the contours of three-dimensional cell clusters observed in practical work are more irregular. In fact, this irregular pattern is mainly caused by external force in the puncture smear process. External forces that cause irregularities in the contours of the three-dimensional cell clusters also cause changes in the number of peripheral cells, which may exceed the limit of “microfollicle” (less than 15). These irregular three-dimensional cell clusters with more than 15 peripheral cells will give observers an illusion that they do not meet the definition of “microfollicle”. However, it turns out that these irregular three-dimensional cell clusters are also of high prompt value for follicular neoplasm. This shows that there are great limitations in judging whether the three-dimensional cell cluster conforms to the “microfollicle” structure only by two limited conditions in the standardized definition of “microfollicle” in practical work, which further proves that it is more reasonable to judge the “microfollicle” structure according to the total number of cells of the three-dimensional cell cluster. In conclusion, it is a very challenging task to accurately calculate the peripheral cell number and the upper limit of the total cell number of three-dimensional cell clusters with diagnostic value for follicular neoplasm, because when the contours of three-dimensional cell clusters are irregular, even if the total cell number is consistent, there are many possibilities for the peripheral cell number to change. However, even because of the limitation of technical conditions, we should not avoid solving this problem, and still choose to rely on blind rough estimation to cope with this work with extremely high accuracy requirements. This will lead to the inability to accurately classify three-dimensional cell clusters even though the definition of “microfollicle” is well established, thus ultimately decreasing the diagnostic value of “microfollicle” structure for follicular neoplasm and affecting the self-confidence of pathologists in clinical diagnosis. Therefore, there is an urgent need to establish a set of more reasonable, effective and easy-to-operate standardized solutions to this problem.

Based on the above analysis, specific solutions are established from the following points. (1) A standardized three-dimensional cell cluster type “microfollicle” structure model is established. The main purpose is to reduce the influence of external force on three-dimensional cell clusters and make the cell distribution of three-dimensional cell clusters more in line with the regular and orderly characteristics of human histology. The third edition of TBS report system supplemented and perfected the “microfollicle” structure, which standardized the three-dimensional cell cluster structure to a great extent, resulting in smoother and more regular cell cluster contours and more orderly arrangement of peripheral cells, and laying the foundation for the derivation of the calculation formula of the total number of cells based on this standardized model. (2) The determination of the upper limit of the total number of cells in the standardized three-dimensional cell cluster type “microfollicle” model and the derivation of the calculation formula of the total number of cells of the three-dimensional cell cluster. (3) Counting of the total number of cells of the three-dimensional cell cluster in thyroid puncture smear.

According to two limited conditions in the definition of “microfollicle” (the number of peripheral cells is less than 15; peripheral cells are surrounded by a circle, at least ⅔ circle), and the principle that a circle has the largest area among plane figures of equal perimeter, a structure model is constructed (as shown in FIG. 1). In this structure model, small circles marked from 1-20 represent follicular cells around the three-dimensional cell cluster with the radius of r′, where r′−7.5n/2, and 7.5 is the diameter of red blood cells (in microns), and n stands for the ratio of the diameter of follicular cells to the diameter of red blood cells. Pathologists often use the diameter of red blood cells as a reference to measure the size of follicular cells in the pathological diagnosis of thyroid puncture smear, because the diameter of red blood cells is relatively fixed and easy to identify in puncture smear. An inner circle with the radius of r is a circle surrounded by peripheral cells. According to the definition, there are at most 14 peripheral cells (black circles marked with 1-14 in FIG. 1), and the definition also requires that peripheral cells enclose at least ⅔ circle, and the number of peripheral cells must be divisible by 4 in order to enclose a complete circle, so that a maximum of 20 peripheral cells are required to enclose a complete circle when the above conditions are satisfied. At this time, the area of the inner circle surrounded by peripheral cells is the largest, that is, the total number of follicular cells that may be accommodated in a circle is the largest. Therefore, the standardized three-dimensional cell cluster type “microfollicle” structure model is a complete circle surrounded by 20 peripheral cells (as shown in FIG. 1).

To calculate the upper limit of the total number of follicular cells that may be accommodated in a three-dimensional cell cluster, the maximum area(S) of the inner circle is calculated first, then the maximum cross-sectional area (S′) of a single follicular cell is calculated, and then the value of S/S′ is calculated, where the value represents the maximum number of follicular cells that may be accommodated, and then 14 peripheral cells are added to obtain the upper limit of the total number of three-dimensional cell cluster type “microfollicle” cells. In the process of calculation, the circumference C′ of the ring formed by the line passing through the peripheral cell centers is calculated, where the circumference C′ is approximately regarded as the circumference of a regular 20-sided polygon with a side length of 2r′. The derivation steps are as follows:
circumference of outer circle:

$${C}^{′} = 2 π ( r + {r}^{′} ) = 2 π r + 2 π {r}^{′} = C + 2 π {r}^{′}$$

$${C}^{′} \approx 20 \times 2 {r}^{′} = 20 \times 2 \times ( 7.5 n / 2 ) ;$$

circumference of inner circle:

$$C = {C}^{′} - 2 π {r}^{′} = 20 \times 2 ( 7 \text{.5} n / 2 ) - 2 π ( 7 \text{.5} n / 2 ) = ( 20 \times 2 - 2 π ) ( 7 \text{.5} n / 2 ) ;$$

the maximum area of a circle surrounded by peripheral cells:

$$S = π {r}^{2} = {π ( C / 2 π )}^{2} = {( 20 \times 2 - 2 π )}^{2} {( 7 \text{.5} n / 2 )}^{2} / 4 π ;$$

the maximum cross-sectional area of a single follicular cell: S′=πr′²=π(7.5n/2)²; and upper limit of the total number of cells in the circle surrounded by peripheral cells:

$$S / {S}^{′} = {( 20 \times 2 - 2 π )}^{2} / 4 {π}^{2} = {[ ( 20 / π ) - 1 ]}^{2} = 28.830743 \; 64071565 \approx 28 ( cells ) .$$

However, the three-dimensional cell cluster composed of follicular cells in thyroid nodules is a hollow sphere (that is, thyroid microfollicle structure) at the histological level of human body. When the cell cluster absorbed by puncture is smeared on a glass slide and covered with a cover glass, the probability of double-layer overlapping area in the three-dimensional cell sphere is higher due to horizontal force and vertical pressure, so it is more reasonable and the error rate is lower to estimate according to the double-layer overlapping. Peripheral cells are tiled in a circle, so the value “28” calculated above is the upper limit of single-layer follicular cells in the three-dimensional cell cluster, so finally, the upper limit of the total number of follicular cells (double-layer follicular cells) in the three-dimensional cell cluster is:

$$2 ( S / {S}^{′} ) \approx 2 \times 28 = 56 ( cells ) .$$

That is, the upper limit of the total number of three-dimensional cell cluster type “microfollicle” cells is:

$$2 ( S / {S}^{′} ) + 14 \approx 56 + 14 = 70 ( cells ) .$$

That is, the upper limit of the total number of standardized three-dimensional cell cluster type “microfollicle” cells is 70, that is, when the total number of cells of the three-dimensional cell cluster is less than or equal to 70, the three-dimensional cell cluster should be judged as a “microfollicle” structure, and when the total number is more than 70, the three-dimensional cell cluster should be judged as a medium follicle.

It may be seen that in a three-dimensional cell cluster, the upper limit of follicular cells that may be accommodated in a circular cavity surrounded by 20 peripheral follicular cells is 2[(20/π)−1]², and when the number of peripheral follicular cells is N, at most “2[(N/π)−1]²” follicular cells with the same size may be accommodated in the circular cavity surrounded by peripheral cells of the three-dimensional cell cluster, that is, the calculation formula of the total number of cells of the three-dimensional cell cluster is:

2[(N/T)−1]²+N, and N should be divisible by 4 (note: only when N is divisible by 4 may a circular cavity be enclosed).

The three-dimensional cell clusters actually observed in pathological diagnosis of thyroid puncture cell smears are often irregular in contour, let alone having relatively fixed number of peripheral cells. The essential function of the two limitations of “microfollicle” structure is to limit the total number of cells of the three-dimensional cell clusters, so the most fundamental problem to solve the boundary of three-dimensional cell clusters is to count the total number of cells of the three-dimensional cell clusters, thus avoiding the problem that the three-dimensional cell clusters conforming to the definition of “microfollicle” do not match with the actual three-dimensional cell clusters with irregular contours and inconsistent numbers of peripheral cells, so that the definition of the three-dimensional cell cluster structure model is solved by the model itself without confusing model problems with actual problems, which makes it more reasonable to solve the counting scheme by establishing a model, and the implementation is relatively simplified.

So, what kind of counting scheme may be adopted to estimate a more reasonable value? Through the study, it is considered that the “2[(N/π)−1]²+N” model may be used to estimate total number of cells in crowded and overlapping unidentifiable areas of a three-dimensional cell cluster, and then total number of cells in tiled identifiable areas may be counted by visual observation under a microscope, and the sum of the last two parts of the total number of cells is the total number of cells of the three-dimensional cell cluster.

Firstly, a big circle (representing a circle surrounded by peripheral cells) is drawn first, and all the crowded and overlapping unidentifiable areas of a three-dimensional cell cluster are enclosed in the big circle, and then small circles (representing peripheral cells) are drawn with actual diameters of follicular cells, and the small circles are surrounded around the big circle. In the process of drawing, the diameter of the big circle is properly adjusted, so that the small circles may completely surround the big circle on the premise that the total number of small circles may be divisible by 4, and the tiled cells and cell-free areas should not be enclosed in the big circle as far as possible. Then, according to the “2[(N/π)−1]²+N” model, the total number of cells in the crowded and overlapping unidentifiable areas of the three-dimensional cell cluster is counted. Cell-free areas that appear during this process are supplemented by black circles drawn with the actual diameters of the follicular cells, and then the sum of the total number of cells in the crowded and overlapping unidentifiable areas and tiled identifiable areas are calculated. Finally, the total number of supplementary cells (twice the number of black circles) is subtracted from the total number of cells to obtain the total number of cells of the three-dimensional cell cluster.

The specific embodiment is as follows.

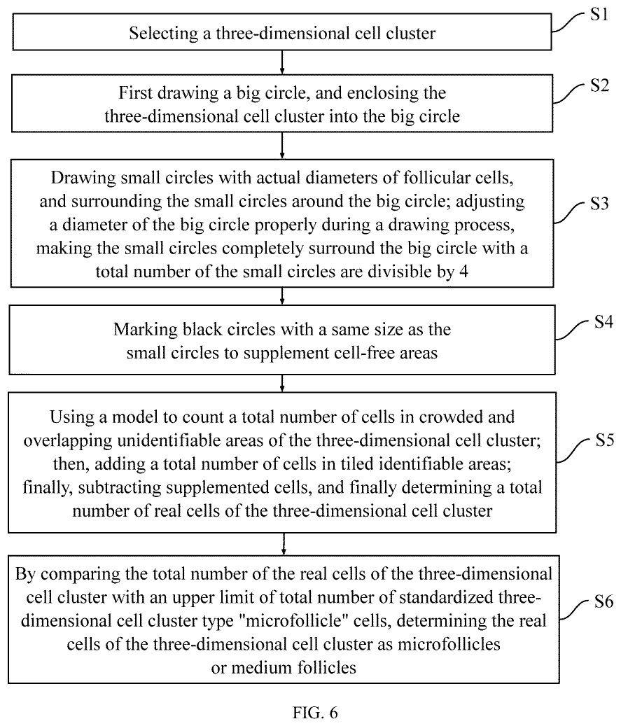

In this embodiment, as shown in FIG. 6, the method for establishing the estimation model of the total number of the cells of the three-dimensional cell cluster in the thyroid puncture smear includes:
S1: selecting a three-dimensional cell cluster with crowded and overlapping follicular cells (as shown in FIG. 2);
S2: first drawing a big circle (representing a circle surrounded by peripheral cells), and enclosing all crowded and overlapping unidentifiable areas of the three-dimensional cell cluster into the big circle (as shown in FIG. 3);
S3: drawing small circles (representing the peripheral cells) with actual diameters of the follicular cells, and surrounding the small circles around the big circle; adjusting a diameter of the big circle properly during a drawing process, making the small circles completely surround the big circle with the total number of small circles are divisible by 4, and trying not to enclose tiled cells and cell-free areas into the big circle (as shown in FIG. 4);
S4: marking black circles with a same size as the small circles (representing peripheral follicular cells) to supplement cell-free areas (as shown in FIG. 5), namely, a total number of supplemented cells is 2×3=6 (cells);
S5: using a “2[(N/π)−1]²” model to count a total number of cells in the crowded and overlapping unidentifiable areas of the three-dimensional cell cluster as 2[(20/π)−1]²≈56 (cells); then, adding a total number of cells in tiled identifiable areas as 56+40=96 (cells); finally, subtracting six supplemented cells to obtain a total number of real three-dimensional cell cluster cells as 96−6=90 (cells); and
S6: classifying the three-dimensional cell cluster as a medium follicle, because 90 cells are more than 70 cells (an upper limit of a total number of three-dimensional cell cluster type “microfollicle” cells is 70), so the three-dimensional cell cluster does not meet a definition of three-dimensional cell cluster type “microfollicle”.

Compared with the related art, the method for establishing the estimation model of the total number of the cells of the three-dimensional cell cluster in the thyroid puncture smear provided by the disclosure has following beneficial effects.

The disclosure provides a method for establishing an estimation model of a total number of cells of a three-dimensional cell cluster in a thyroid puncture smear, which may reduce the influence of external force on the three-dimensional cell cluster, so that the cell distribution of the three-dimensional cell cluster is more in line with the regular and orderly characteristics of human histology. The method may avoid the problem that the three-dimensional cell clusters conforming to the definition of “microfollicle” do not match with the actual three-dimensional cell clusters with irregular contours and inconsistent numbers of peripheral cells, so that the definition of the three-dimensional cell cluster structure model is solved by the model itself without confusing model problems with actual problems.

The above describes only the embodiment of the disclosure, which does not limit the patent scope of the disclosure. Any equivalent structure or equivalent process transformation made by using the contents of the specification and drawings of the disclosure, or directly or indirectly applied to other related technical fields, are equally included in the patent protection scope of the disclosure.

What is claimed is:

1. A method for establishing an estimation model of a total number of cells of a three-dimensional cell cluster in a thyroid puncture smear, comprising following steps:
S1: selecting a three-dimensional cell cluster;
S2: first drawing a big circle, and enclosing the three-dimensional cell cluster into the big circle;
S3: drawing small circles with actual diameters of follicular cells, and surrounding the small circles around the big circle; adjusting a diameter of the big circle properly during a drawing process, making the small circles completely surround the big circle with a premise of a total number of the small circles are divisible by 4;
S4: marking black circles with a same size as the small circles to supplement cell-free areas;
S5: using a model to count a total number of cells in crowded and overlapping unidentifiable areas of the three-dimensional cell cluster; then, adding a total number of cells in tiled identifiable areas; finally, subtracting supplemented cells, and finally determining a total number of real cells of the three-dimensional cell cluster; and
S6: by comparing the total number of the real cells of the three-dimensional cell cluster with an upper limit of total number of standardized three-dimensional cell cluster type “microfollicle” cells, determining the real cells of the three-dimensional cell cluster as microfollicles or medium follicles.

2. The method for establishing the estimation model of the total number of the cells of the three-dimensional cell cluster in the thyroid puncture smear according to claim 1, wherein in the S1, the three-dimensional cell cluster with crowded and overlapping unidentifiable follicular cells are selected.

3. The method for establishing the estimation model of the total number of the cells of the three-dimensional cell cluster in the thyroid puncture smear according to claim 1, wherein in the S2, the big circle represents a circle surrounded by the peripheral cells, and all the crowded and overlapping unidentifiable areas of the three-dimensional cell cluster are enclosed in the big circle.

4. The method for establishing the estimation model of the total number of the cells of the three-dimensional cell cluster in the thyroid puncture smear according to claim 1, wherein in the S3 and the S4, the small circles represent peripheral follicular cells; in the S3, when the small circles are completely around the big circle while the total number of the small circles is completely divided by 4, tiled cells and cell-free areas are required not to be enclosed in the big circle.

5. The method for establishing the estimation model of the total number of the cells of the three-dimensional cell cluster in the thyroid puncture smear according to claim 1, wherein in the S5, a “2[(N/π)−1]²” model is used to count the total number of the cells in the crowded and overlapping unidentifiable areas of the three-dimensional cell cluster.

6. The method for establishing the estimation model of the total number of the cells of the three-dimensional cell cluster in the thyroid puncture smear according to claim 1, wherein the upper limit of the total number of the three-dimensional cell cluster type “microfollicle” cells is 70.
